(19) United States
(12) Patent Application Publication
(10) Pub. No.: US 2008/0078212 A1
(43) Pub. Date: Apr. 3, 2008

(54) Blower for a textiles processing machine

(75) Inventor: William Tak Ming Tsui, Causeway Bay (HK)

Correspondence Address: KRATZ, QUINTOS & HANSON, LLP, 1420 K Street, N.W., Suite 400, WASHINGTON, DC, 20005, US

(73) Assignee: FALMER INVESTMENTS LIMITED, Tortola (VG)

(21) Appl. No.: 11/706,346

(22) Filed: Feb. 15, 2007

(30) Foreign Application Priority Data
Oct. 2, 2006 (EP) 06255093.4

(51) Int. Cl. D06B 3/28; F03B 3/00

(52) U.S. Cl. 68/5 R; 415/4.5

(57) ABSTRACT

A blower for use with a textiles processing machine such as a dyeing machine including an intake port and an outlet port each in communication with an impeller that draws air in through the intake port and discharges air through the outlet port, the intake port and the outlet port being arranged such that air is drawn in in a direction opposite to but substantially parallel to a direction in which air is discharged.

### BACKGROUND OF THE INVENTION

The present invention relates to a blower, particularly but not exclusively for use with a textiles processing machine.

Jets of air can be applied to textiles during a fabric dyeing process, such as piece dying. A jet of air is directed onto fabric in a piece dying machine to loosen the fabric, giving a more even dyeing effect. The jet is delivered by a nozzle connected to a blower. The blower has an air intake (suction) and an air outlet (discharge); these are conventionally arranged along perpendicular directions. An example of such a blower is given in WO 95/08662.

Blowers of this type are often installed by the side of the associated dyeing machine, and the combined blower and machine can occupy a large amount of space. This impacts on the design of dyeing machines, since the large size makes it undesirable to provide a separate blower for each type in a multiple tube loading dyeing machine. Thus, two or more tubes share a blower. This necessitates a manifold to divide the stream of air from the blower and distribute it between the tubes. It is difficult to achieve an even distribution of air flow among the tubes, so that each tube may experience a different force in the air jet, resulting in uneven dyeing. Also, in the event of blower malfunction, all the tubes sharing that blower must be shut down to await blower maintenance.

Thus there is a requirement for an improved blower.

### SUMMARY OF THE INVENTION

Accordingly, a first aspect of the present invention is directed to a blower comprising: an intake port; an outlet port; and an impeller in communication with the intake port and the outlet port so as to be operable to draw air in through the intake port and discharge air through the outlet port; the intake port and the outlet port being arranged such that air is drawn in a direction opposite to but substantially parallel to a direction in which air is discharged.

Thus, the blower is provided with an air intake and an air outlet that are aligned in the same direction. This allows the overall size of the blower to be reduced compared to conventional blowers having a perpendicular intake and outlet arrangement. Also, the blower may be connected to a dyeing machine using a smaller and/or shorter pipe or tube than is required for a conventional blower. This reduced space occupancy allows a multiple tube dyeing machine to be provided with a separate and dedicated blower for each tube. Individual control of the blower speed for each tube can then be achieved. In addition, maintenance is more flexible, since failure of a blower only affects one tube. The remaining tubes in the machine can remain operational while the failed blower is repaired or replaced. Further, the need for a manifold for distributing air from one blower to a plurality of tubes is eliminated.

The outlet port may surround the intake port. This provides for an especially compact blower.

The outlet port may be substantially concentric with the intake port. In addition to compactness, this provided a symmetric shape for the outlet port, which allows a more even jet of air to be discharged from the blower.

Further, the outlet port may be annular. An outlet port that is both smoothly shaped and symmetric is particularly well-adapted for providing an even distribution of air throughout a textiles machine.

The blower may comprise an outlet passage to direct air from the impeller to the outlet port. It may further comprise an intake passage to direct air from the intake port to the impeller, the outlet passage surrounding the intake passage. This configuration builds on the arrangement of the outlet port surrounding the inlet port, and offers a highly compact design for the blower.

At least part of the outlet passage may have a spiral shape with a longitudinal axis substantially parallel to the direction in which air is discharged. This improves the distribution and rate of air discharge through the outlet port. A spiral shape gives a longer outlet passage within the same overall length of the blower, and a longer passage offers more scope for controlling the air flow along the passage through engineering of the outlet passage shape and dimensions.

Also, at least part of the outlet passage is divided into two or more sub-passages extending side by side. Again, this enhances the evenness of the air discharge, and offers greater scope for manipulating the width of the outlet passage to modify the air flow.

For example, the outlet passage may increase in cross-sectional area between the impeller and the outlet port. By Bernoulli's law, an increase in area in a flow channel decreases the kinetic energy of the flowing fluid, in this case air, and increases the pressure. Thus, the jet of air discharged by the blower is more forceful and better able to loosen fabric in a textiles machine.

The invention further relates to a textiles processing machine provided with at least one blower according to the first aspect of the invention, the blower operable to discharge air onto textiles being processed within the machine.

In some embodiments, the textiles processing machine may have two or more tubes and is provided with a blower for each tube, each blower operable to discharge air onto textiles being processed within its associated tube.

A second aspect of the invention is directed to a method of blowing air onto textiles during processing of the textiles in a textiles processing machine, the method comprising: using an impeller to: draw air in through an intake port along a first direction; and to discharge air onto the textiles in the textiles processing machine through an outlet port along a second direction opposite to but substantially parallel to the first direction.

### BRIEF DESCRIPTION OF THE DRAWINGS

For a better understanding of the invention and to show how the same may be carried into effect reference is now made by way of example to the accompanying drawings in which:

FIG. 1 shows a cross-sectional view of a blower according to an embodiment of the present invention;

FIG. 2 shows a first cross-sectional perspective view of a housing for the blower of FIG. 1;

FIG. 3 shows a second cross-sectional perspective view of the housing of FIG. 2;

FIG. 4 shows a schematic representation of a textiles processing machine fitted with a blower according to an embodiment of the invention; and

FIG. 5 shows a schematic representation of a further textiles processing machine fitted with multiple blowers according to an embodiment of the invention.

### DETAILED DESCRIPTION

FIG. 1 shows a cross-sectional view of an embodiment of a blower according to the present invention. The blower 20 comprises two main parts: an impeller, and a housing defining an air intake and an air outlet. The impeller 4 may be any conventional impeller used for air blowers and fans. It is substantially dish-shaped and has a plurality of impeller blades extending radially from a central hub. The hub of the impeller 4 is mounted on a drive shaft 2 of a driving motor 1, by which the impeller can be rotated in the conventional manner.

Fitted over the impeller 4 is a housing 5, which is mounted to the driving motor 1 by a rear plate 11, through which the drive shaft 2 extends. The housing 5 is circular in cross-section (in a plane orthogonal to the rotational axis of the impeller 4) and is positioned concentrically with the impeller 4 and the drive shaft 2. A mechanical seal 3 is disposed between the rear plate 11 and the drive shaft 2, to isolate the housing 5 from vibrations of the motor 1, drive shaft 2 and impeller 4. The housing 5 defines an intake port 12 and an outlet port 13, and passages connecting the ports 12, 13 with the impeller 4. The intake port 12 and the outlet port 13 lie substantially in the same plane. In this example, the intake port 12 is positioned concentrically within the outlet port 13, the outlet port 13 surrounding the inlet port 12 and being annular in shape.

The housing 5 includes a central tube 7 of circular cross-section that extends along the longitudinal axis defined by the drive shaft 2, from the intake port 12 to an entrance region of the impeller. The tube defines an intake passage, along which air is drawn from the intake port 12 to the impeller 4. Thus, the intake passage directs air form the intake port 12 to the impeller 4.

The housing 5 also comprises a tubular outer wall 14 and a tubular inner wall 15, each arranged coaxially with the central tube. The outer wall 14 surrounds the inner wall 15, which in turn surrounds the central tube 7. The outer wall 14 and the inner wall 15 are spaced apart from one another, the space therebetween defining an outlet passage 6 which extends from a discharge region of the impeller 4 to the outlet port 13. Air leaving the impeller 4 is thereby directed from the impeller 4 to the outlet port 13. The outlet passage 6 is shaped such that its first end adjacent to the impeller 4 is positioned around the outside perimeter of the impeller blades, and its second end, which defines the outlet port 13, surrounds the central tube 7. In this example, the impeller 4 has a greater diameter than the central tube 7, so to achieve the described configuration of the outlet passage, the inner wall 15 and the outer wall 14 have a decreasing outer diameter as they extend from the impeller 4 to the outlet port 13. In other examples, however, the walls may have a substantially constant or even an increasing diameter.

The central tube 7 is held in place within the inner wall 15 by plates 16 that extend between the two parts.

The front end of the blower 20, being in the plane containing the intake port 12 and the outlet port 13, is provided with an annular connection flange 8 that surrounds the outlet port 13. The flange 8 allows the blower 20 to be connected to a textiles processing machine, for example by bolts or rivets extending through holes in the flange 8 and fastened to a wall of the machine, or to an end of a pipe that leads into the machine.

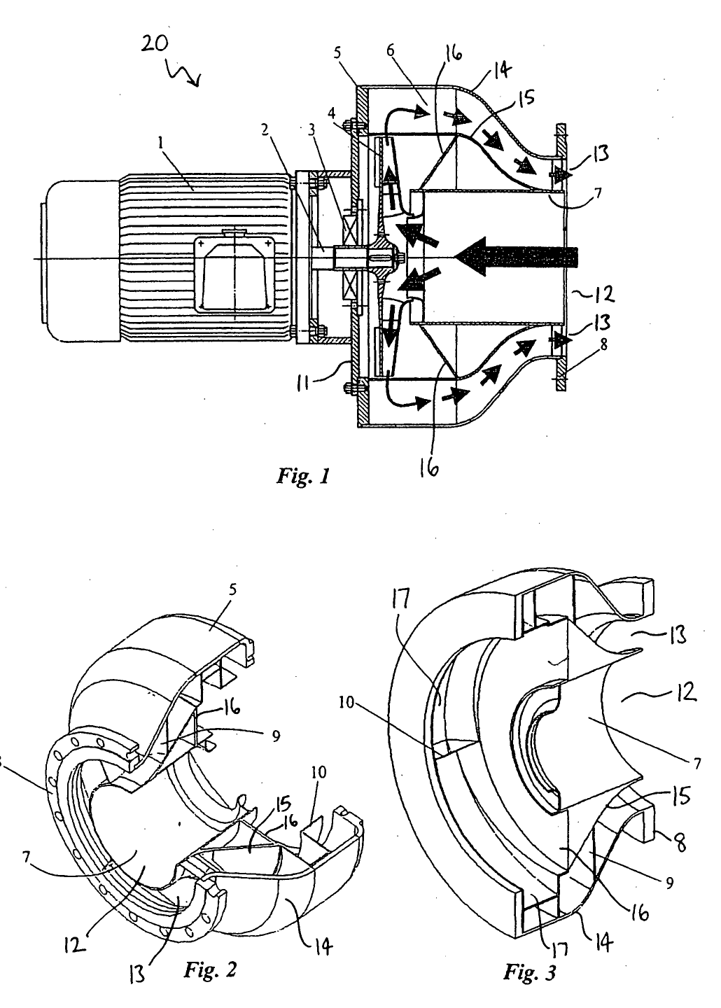

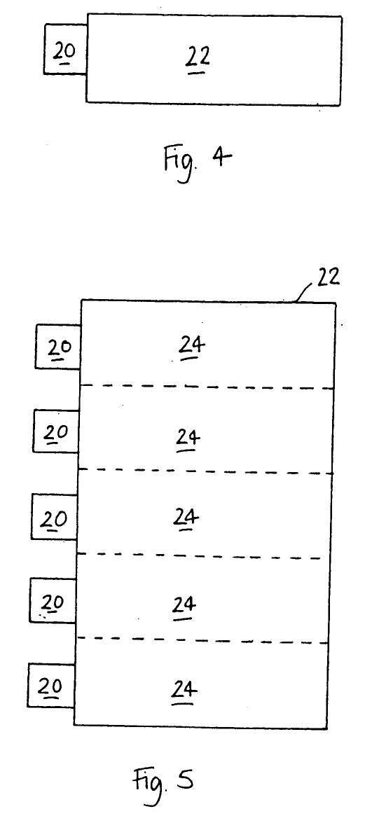

FIG. 2 shows a quarter-sectioned perspective side-front view of the housing 5, and FIG. 3 shows a half-sectioned perspective side-rear view of the housing 5. These figures illustrate how, in this example, the outlet passage 6 is divided into a number of sub-passages that extend side by side along the outlet passage 6. Each sub-passage comprises a circular passage and a spiral passage. The first end of the outlet passage 6, adjacent to the impeller 4, is formed as several circular passages 10, arranged in series around the outer perimeter of the impeller 4 and each extending part of the way around the outer perimeter of the impeller 4, and each arranged to receive air from the impeller 4. Each circular passage 10 leads to a spiral passage 9 which follows a substantially helical path in the space between the inner wall 15 and outer wall 14, spiraling around the central tube 7 to the outlet port 13.

Each of the circular passages 10 has a cross-sectional flow area (the area through which air can flow from the impeller 4) that increases along the length of the passage 10. As can be seen in FIG. 3, this is achieved by plates 17 disposed inside the circular passage 10 in a circumferential manner and which have a first end positioned at a point between the inner wall 15 and the outer wall 14, and which extend in a smooth curve around part of the circumference of the housing 5 to a second end positioned closer to or in contact with the inner surface of the outer wall 14.

The cross-sectional flow area of the spiral passages 9 similarly increases along the length of the spiral passages 9 from the circular passages 10 to the outlet port 13.

To operate the blower, the motor 1 is activated to rotate the impeller 4. Rotation of the impeller produces a pressure differential between its entrance region and its discharge region, and hence between the intake port 12 and the outlet port 13 which are respectively in communication with those regions by virtue of the inlet passage 7 and the outlet passage 6. The pressure differential, and negative pressure at the entrance region of the impeller 4 causes air to be drawn in through the intake port 12 and to travel along the central tube 7 to the impeller 4. The rotation of the impeller 4 imparts centrifugal force to the air, which passes across the impeller 4, and is forced into the outlet passage 6. The air then travels to the outlet port 13 by way of the circular passages 10 and the spiral passages 9; upon reaching the outlet port 13 it is discharged as a jet or air. The described arrangement of the inlet port 12 and the outlet port 13 are such that the air is drawn in and subsequently discharged along directions which are opposite but substantially parallel. The direction of air flow from intake to discharge is shown by arrows in FIG. 1.

The increase in the flow area along the lengths of the circular paths 10 and the spiral paths 9 slows down the speed of air flow inside the paths, converting part of the kinetic energy of the propagating air to an increase in pressure, in accordance with Bernoulli's law. This pressure increase allows the air to be discharged as a jet, suitable to be directed into a textile machine for the loosening of fabric being dyed therein.

The housing can be made from any material suitable for use in the environment of a textiles processing machine and which can be formed into the desired shape, such as a metal, including steel, stainless steel or aluminum, or a moulded plastics material.

The blower of the present invention is not limited to the example shown in FIGS. 1, 2 and 3. The intake port and outlet port may be differently arranged, yet still achieve the desired operation of air being taken in and discharged along parallel but opposite directions. For example, the two ports need not lie in the same plane; they may be displaced one from another along the direction of air intake/discharge. A displaced arrangement may be more or less suitable, depending on how the blower is to be mounted onto a textiles processing machine. Further, the ports need not have the circular and annular configurations illustrated in FIGS. 1, 2 and 3; other shapes may be used, although smooth curved shapes may be preferred to give a smooth and even air flow. The two ports need not be concentrically arranged. Instead, the inlet port may be radially offset within the outlet port, so that the outlet port merely surrounds the inlet port. Moreover, the outlet port may not surround the inlet port; the two ports may be arranged adjacent to one another instead, or even spaced apart. Again, the relative arrangement of the ports may be chosen according to the proposed fitting of the blower onto a textiles machine. Also, the outlet passage may be divided into any number of sub-passages, or may be undivided so that there are no sub-passages.

FIG. 4 shows a simple schematic representation of a textiles processing machine 22, such as a piece dyeing machine, fitted with a blower 20 in accordance with the present invention. The described configuration allows the blower to be very compact, and hence to be conveniently fitted to a machine in such a way that the blower and machine in combination occupy relatively little space. This is of particular advantage for multiple tube loading dyeing machines. The machine 22 shown in FIG. 4 may be a single tube machine, comprising one compartment within which fabric is dyed and fitted with one blower to provide a jet of air onto fabric within the single compartment.

FIG. 5, in contrast, shows a simple schematic representation of a machine 22 with multiple tubes 24. Each tube 24 corresponds to a dyeing compartment; the division of the machine 22 in this way is represented by the dashed lines in FIG. 5, the machine comprises five tubes 24 in this example. Each tube 24 is provided with a dedicated blower 20, each configured to provide a jet of air into its associated compartment during fabric dyeing. This one-to-one correspondence between blowers and tubes is made possible by the compact nature of blowers according to the present invention, as compared to conventional arrangements in which a bulky blower is used to provide air to two or more tubes via a manifold. The provision of a separate blower for each tube eliminates the need for a manifold, reduces machine down-time in that only one tube needs to be taken out of operation in the vent of failure of a blower, and offers individual control of the blowers for each tube so that more even dyeing can be achieved across the machine as a whole.

Although the use of a separate blower for every tube is of particular benefit, blowers as described herein may also be associated with more than one tube in a machine, including the use of a manifold, if desired. The smaller size of such blowers as compared to known blowers still offers advantages.

Although the described blowers are particularly suited for use with textiles processing machines, particularly dyeing machines, the invention is not so limited. The blowers may be used for other applications in which the described arrangement of taking in and discharging air along parallel but opposite directions is found to be beneficial.

1. A blower comprising:
an intake port;
an outlet port; and
an impeller in communication with the intake port and the outlet port arranged to draw air in through the intake port and discharge air through the outlet port;
the intake port and the outlet port being arranged such that air is drawn in in a direction opposite to but substantially parallel to a direction in which air is discharged.

2. The blower according to claim 1, in which the outlet port surrounds the intake port.

3. The blower according to claim 2, in which the outlet port is substantially concentric with the intake port.

4. The blower according to claim 2, in which the outlet port is annular.

5. The blower according to claim 1, including an outlet passage to direct air from the impeller to the outlet port.

6. The blower according to claim 5, further including an intake passage to direct air from the intake port to the impeller, the outlet passage surrounding the intake passage.

7. The blower according to claim 5, in which at least part of the outlet passage has a spiral shape with a longitudinal axis substantially parallel to the direction in which air is discharged.

8. The blower according to claim 6, in which at least part of the outlet passage has a spiral shape with a longitudinal axis substantially parallel to the direction in which air is discharged.

9. The blower according to claim 5, in which at least part of the outlet passage is divided into two or more sub-passages extending side by side.

10. The blower according to claim 5, in which the outlet passage increases in cross-sectional area between the impeller and the outlet port.

11. The blower according to claim 6, in which the outlet passage increases in cross-sectional area between the impeller and the outlet port.

12. The blower according to claim 7, in which the outlet passage increases in cross-sectional area between the impeller and the outlet port.

13. The blower according to claim 8, in which the outlet passage increases in cross-sectional area between the impeller and the outlet port.

14. A textiles processing machine provided with at least one blower according to claim 1, the blower operable to discharge air onto textiles being processed within the machine.

15. The textiles processing machine according to claim 14, the machine having two or more tubes and being provided with a blower for each tube, each blower arranged to discharge air onto textiles being processed within its associated tube.

16. A textiles processing machine provided with at least one blower according to claim 2, the blower operable to discharge air onto textiles being processed within the machine.

17. The textiles processing machine according to claim 16, the machine having two or more tubes and being provided with a blower for each tube, each blower operable to discharge air onto textiles being processed within its associated tube.

18. A method of blowing air onto textiles during processing of the textiles in a textiles processing machine, the method comprising:
using an impeller to:
draw air in though an intake port along a first direction; and to
discharge air onto the textiles in the textiles processing machine through an outlet port along a second direction opposite to but substantially parallel to the first direction.
